(19) United States
(12) Patent Application Publication
(10) Pub. No.: US 2019/0345866 A1
(43) Pub. Date: Nov. 14, 2019

(54) CONDUIT SYSTEM AND A METHOD OF ASSEMBLING A CONDUIT SYSTEM

(71) Applicant: Volvo Truck Corporation, Göteborg (SE)

(72) Inventors: Bhargav Varanasi, Visakhapatnam (IN); Anantha Rama Krishna Lakshmi Narayana Alla, Bangalore (IN); Manesh Bhagat, Bangalore (IN)

(21) Appl. No.: 16/474,429

(22) PCT Filed: Dec. 20, 2017
(86) PCT No.: PCT/EP2017/083847

§ 371 Date: Jun. 27, 2019

(30) Foreign Application Priority Data
Jan. 3, 2017 (IN) 201741000200

(51) Int. Cl. F01N 13/18; F16L 27/073; F16L 27/10

(52) U.S. Cl. CPC F01N 13/1872; F01N 13/1811; F01N 13/1855; F01N 2590/08; F16L 27/1004; F01N 2450/20; F01N 2450/24; F16L 27/073

(57) ABSTRACT

The invention relates to a conduit system comprising a first conduit (2) having a first engagement portion (3), and a second conduit (12) having a second engagement portion (13), wherein the first conduit (2) and the second conduit (12) are adapted to be connected to each other by means of the first and second engagement portions (3, 13). The first and second engagement portions (3, 13) comprises a first and second slide surface (4, 14), respectively. Said slide surfaces (4,14) extend radially outwards and has an inclination of 20-90° to a respective longitudinal axis (A) of the respective engagement portions. Said conduit system (1) further comprises spring means (20) arranged to urge one of the first and second slide surfaces (4, 14) towards the other one of said first and second slide surfaces (4, 14). The present invention also relates to a vehicle being provided with such a conduit system and to a method of assembling a conduit system for a vehicle.

### TECHNICAL FIELD

The invention relates to a conduit system for a vehicle. The present invention also relates to a vehicle being provided with such a conduit system and to a method of assembling a conduit system for a vehicle.

The invention can be applied in heavy-duty vehicles, such as trucks, buses and construction equipment. Although the invention will be described with respect to a truck, the invention is not restricted to this particular vehicle, but may also be used in other vehicles such as buses, wheel loaders, articulated haulers, excavators, backhoe loaders, boats, ships and cars. The invention may also be employed in industrial engines.

### BACKGROUND

Vehicles, for example trucks, are provided with conduit systems for transfer of e.g. exhaust gases from the engine to e.g. a catalyst, muffler and finally the ambient air. Many different sorts of conduit systems exist, but it is quite common that they comprise at least a first and second pipe and/or hose portion that are connected to each other. When a first and second pipe and/or hose portion are fixedly connected to each other, there is a risk of damages to them by caused by relative movement between them. Such movements may occur e.g. during assembly or use, for example by engine vibrations. If one or both of the pipes and/or hoses are damaged, exhaust gases may leak to the environment which not only gives rise higher emissions but also to fire and safety issues. Furthermore, a damaged pipe and/or hose results in more noise from the vehicle. It may therefore be desirable that the joint allows for certain movement between the first and second pipe and/or hose portion in order to avoid damages on them caused by relative movement between them or vibrations.

An example of an exhaust gas system which allows a certain movement between a first and a second pipe is disclosed in EP 1 329 608. The two pipes overlap each other and an annular radially deformable sealing element is arranged between them. The overlapping regions are held together by a pipe clip under compression of the sealing element. By this arrangement, the sealing element reduces vibrations in the pipes.

However, certain drawbacks exist also with the system in EP 1 329 608. For example, it only reduces vibrations between the pipes but it does not allow for rotational movement. Hence, the risk of damages caused by forces acting in the rotational direction still exist. It is also not serviceable. Hence, if it is damaged, the entire system must be replaced. Furthermore, with the design of the system, there is a risk of undesired leakage of e.g. exhaust gases from the conduit system.

### SUMMARY

It is an object of the present invention to provide a conduit system which reduces the risk of failure of the conduit system, is possible to service and re-use undamaged parts of while at the same time provides a reduced risk of fluid leakage also before any failure.

According to a first aspect, the present invention at least partly solves the above-identified and other objectives by providing a conduit system for conveying a high temperature fluid, such as an exhaust gas from an engine, according to claim 1. According to a second aspect, the present invention also solves the above-identified and other objectives by providing a vehicle according to claim 12. According to a third aspect, the present invention also solves the above-identified and other objectives by providing a method of assembling a conduit system according to claim 13.

The conduit system according to the first aspect of the present invention comprises a first conduit having a first engagement portion, and a second conduit having a second engagement portion. The first conduit and the second conduit are adapted to be connected to each other by means of the first and second engagement portions. The first engagement portion comprises a first slide surface, said first slide surface extending radially outwards from a longitudinal axis of the first conduit at the first engagement portion of the first conduit and has an inclination of 20-90° to said longitudinal axis, wherein the second engagement portion comprises a second slide surface, said second slide surface extending radially outwards from a longitudinal axis of the second conduit at the second engagement portion of the second conduit and has an inclination of 20-90° to said longitudinal axis. Said conduit system further comprises spring means arranged to urge one of the first and second slide surfaces towards the other one of said first and second slide surfaces, such that the first and second slide surfaces form at least a part of a sealing to prevent fluid from escaping the conduit system.

The respective slide surfaces will be urged towards each other by means of a spring means and thereby provide a sealing that prevents undesired leakage from the joint. As spring means, and not e.g. a pipe clip, hose clamp or weld, are used to hold the engagement portions together, it is possible to disassemble and reassemble the different components for service and repair.

According to an exemplary embodiment, the engagement portions of the first and second conduits are intended to overlap each other when they are assembled.

The first and second slide surfaces may be in contact with each other when they are urged towards each other. It is however not necessary that they are. For example, another component may be provided between them. What is important is that the first and second slide surfaces together with any other further members, forms a seal and that the first and second slide surfaces may move in relation to each other.

As the slide surfaces may slide in relation to each other, it provides for a possibility for the first and second conduits to move in relation to each other. For example, the pipes may rotate in relation to each other and/or be angularly tilted in relation to each other. By that, forces inducing a movement may be handled without damaging the conduits.

According to one exemplary embodiment, the conduits may be angularly tilted in relation to each other by up to 15° in either direction. A possibility to angularly displace the first and second conduits in relation to each other by up to 15° is sufficient to handle the most frequently occurring displacements of the conduits. How large tilting that is possible for a conduit system is La. dependent on the respective lengths of the first and second slide surfaces and also the relative lengths between the first and second slide surfaces.

According to one exemplary embodiment, the conduits may be rotated 360° in relation to each other. Stated differently, there is no protrusion or other locking feature that prevents or limits rotation between the first and second conduit. By that, any rotational movement may be handled without causing damages to the conduits. Furthermore, assembly is simplified as it is possible to rotate the conduits in relation to each other also after they have been assembled.

The inclination of the first and second slide surfaces is to be seen in relation to the longitudinal axis of the first and second engagement portions, respectively. It is however not necessary that the extension of the respective slide surface is straight. It may for example be curved. In that case, it is the angle of the chord of the respective surface that is to be considered, when the chord is drawn between the innermost part and outermost part of the respective surface. The extension of the first and second slide surface is to be considered as the parts of the engagement portions that are intended to face each other and be movable in relation to each other. They may well be connected to other parts of the respective conduits, without those parts being part of the slide surfaces.

According to one exemplary embodiment, the inclination of the first slide surface is 35-80° and more preferably 45-70°. According to one exemplary embodiment, the inclination of the second slide surface is 35-80° and more preferably 45-70°. Slide surfaces having an inclination within the desired ranges have proven to be beneficial as they provide for the desired freedom of movement while at the same time seals the joint effectively.

According to one exemplary embodiment, the first slide surface is longer than the second slide surface. Hence, according to this embodiment, the second slide surface is intended to slide in relation to the first slide surface. The larger difference in length there is, the larger angular tilting may be allowed, as the second slide surface then may slide a longer distance. The possible allowable length difference is however also dependent on other design constraints such as e.g. available space on a vehicle and what is necessary in order to create a suitable sealing.

According to one exemplary embodiment, the first and second conduits are rotationally symmetrical. Rotational symmetrical conduits provide for an easier assembly of the conduits system as no rotational alignment is required. According to one exemplary embodiment, all components used in the conduit system for connecting the first and second conduits to each other are rotationally symmetrical. Also this provides for a simplified assembly.

According to one exemplary embodiment, the difference is inclination between the first and second slide surfaces is less than 5°. Having approximately the same angle of inclination of the first and second slide surfaces is beneficial as they are intended to bear against each other and create a tight seal. If the first and second slide surfaces are not straight, it is the angle at corresponding points, i.e. points of the different surfaces that are intended to be in contact with each other, that should have a difference in inclination that is less than 5°. The inclination should then be measured as described above, i.e. the inclination of the chord of the curved surface.

According to one exemplary embodiment, the inclination of the first and second slide surfaces are the same. Having the same angle of inclination of the first and second slide surfaces, i.e. they are parallel, is beneficial as they are intended to bear against each other and create a tight seal. If the first and second slide surfaces are not straight, it is the angle at corresponding points, i.e. points of the different surfaces that are intended to be in contact with each other, that should have an inclination that is the same. The inclination should then be measured as described above, i.e. the inclination of the chord of the curved surface.

According to one exemplary embodiment, said first conduit is of a rigid character and said second conduit is of a flexible character. The present invention is advantageously used in conduit systems in which one of the conduits is of rigid character and one of the conduits is of flexible character. By rigid character is e.g. meant a pipe of rigid plastics or metal. By flexible character is e.g. meant a flexible hose.

When a rigid conduit is connected to a flexible conduit by means of fixed connection, forces acting in both rotational and/or angular direction causes wear to especially the flexible conduit. By the present invention, the flexible conduit is allowed to move in both angular and rotational direction in relation to the rigid conduit. Thereby, it is subject to less wear and the risk of failure is reduced.

According to one exemplary embodiment, both said first conduit and said second conduit are of rigid character. The present invention may also advantageously be used in conduit systems in which both conduits are of rigid character, such as e.g. pipes of rigid plastics or metal.

According to one exemplary embodiment, both said first conduit and said second conduit are of flexible character. The present invention may also advantageously be used in conduit systems in which both conduits are of flexible character, such as e.g. flexible hoses.

According to one exemplary embodiment, at least one of said first and second slide surfaces have a curved shape. A curved shape of at least one of the first and second slide surfaces is beneficial as it allows for easier relative angular movement of the first and second conduits.

According to one exemplary embodiment, said first slide surface have a curved shape. When the first slide surface is curved, the second slide surface may be either curved or straight and slide along the first slide surface. This is possible when the length of the first slide surface is larger than the length of the second slide surface.

According to one exemplary embodiment, both said first and said second slide surfaces are curved. Hence, according to this embodiment, both slides surfaces are curved and as they are rotationally symmetrical, each of them have the shape of an ovoid segment, such as a spherical segment.

According to one exemplary embodiment, the center of the ovoid segment shaped first slide surface and the center of the ovoid segment shaped second slide surface are common. By this, the first and second slide surfaces can swivel in relation to each other, and thereby, the desired freedom of movement between the first and second conduits is provided for.

According to one exemplary embodiment, said spring means is one of a Belleville washer, wave washer, bellow spring or a coil spring. Belleville washers, wave washers, bellow springs and coil springs are suitable spring means for urging the first and second slide surfaces towards each other.

According to one exemplary embodiment, a first sealing member is provided between said first and said second slide surfaces. By providing a first sealing member between the first and second slide surfaces, an improved fluid sealing may be achieved. Hence, according to this embodiment, the first and second slide surfaces need not be in contact. Instead, one of the first and second slide surfaces may be connected to the first sealing member in such a manner that relative motion therebetween is limited or prevented, and that slide surface and the first sealing member may together slide relative the other one of said first and second slide surfaces.

According to one exemplary embodiment, the coefficient of friction of the first sealing member is equal to or less than 0.2 and more preferably equal to or less than 0.1. A sealing element having a low coefficient of friction provides for an improved relative motion between the first and second slide surfaces, thereby causing less wear to the first and/or second conduits.

According to one exemplary embodiment, lubricant is provided to one or more of the first slide surface, first sealing member and the second slide surface. Lubrication by means of a lubricant is one alternative for providing a suitable low friction for the relative motion between the first and second slide surfaces.

According to one exemplary embodiment, said first sealing member is a low friction gasket, such as a graphite gasket. It is advantageous if the first sealing member has a low coefficient of friction. Graphite has a low coefficient of friction while it at the same time has good sealing properties, is non-corrosive and can withstand high temperatures. It is therefore suitable as material for the first sealing member. A graphite gasket may for example be provided in the form of a graphite coated metal surface.

According to one exemplary embodiment, said first sealing member provides for both rotary and angular movement. As the first and second slide surfaces are intended to be able to move both rotationally and angularly in relation to each other, it is beneficial if also the first sealing member has a design that provides for such movements.

According to one exemplary embodiment, said conduit system further comprises a second sealing member. It may be beneficial to use a second sealing member in order to provide for a fluid tight joint having even further reduced risk of leakage.

According to one exemplary embodiment, the coefficient of friction of the second sealing member is equal to or less than 0.2 and more preferably equal to or less than 0.1. A sealing element having a low coefficient of friction provides for an improved relative motion between the first and second conduits, thereby causing less wear to the first and/or second conduits.

According to one exemplary embodiment, lubricant is provided to one or more of the first second sealing member and any surface it may slide against. Lubrication by means of a lubricant is one alternative for providing a suitable low friction for the relative motion between the second sealing member and any surface it may slide against.

According to one exemplary embodiment, said second sealing member is a graphite gasket. Graphite has a low coefficient of friction while it at the same time has good sealing properties, is non-corrosive and can withstand high temperatures. It is therefore suitable as material for the second sealing member. A graphite gasket may for example be provided in the form of a graphite coated metal surface.

According to one exemplary embodiment, said second sealing member provides for rotational movement. The position of the second sealing member according to this exemplary embodiment makes it sufficient if it only provides for rotational movement.

According to one exemplary embodiment, said conduit system further comprises a locking means for locking the spring means in a biased configuration in which it urges one of the first and second slide surfaces towards the other one of said first and second slide surfaces. A locking means may be used to hold the spring means in a biased condition so that the first and second slide surfaces are urged towards each other. Examples of locking means that may be used are circlips, rivets, bolts and welds.

According to one exemplary embodiment, the locking means are connected to a flange portion of the first engagement portion. Thereby, they may hold the spring means biased towards the first slide surface.

According to one exemplary embodiment, said locking means is a circlip. A circlip is a beneficial means for holding the spring means in a biased condition.

According to one exemplary embodiment, the order of the components in the conduit system is first slide surface, first sealing member, second slide surface, spring means, second sealing member and locking means. According to this exemplary embodiment, the first slide surface and the locking means may be held still, while the first sealing member, second slide surface, spring means and second sealing member may move together in relation to the first slide surface and the locking means.

According to one exemplary embodiment, said conduit system further comprises a flow guide member provided at least partly in the first and second engagement portions of the first and seconds conduits, respectively. A flow guide member may assist in directing e.g. exhaust gases towards the centerline of the conduit system. This assists in further reducing the risk of leakage in the joint.

According to one exemplary embodiment, said flow guide member is a deflector. The deflector is designed as a short pipe with open ends being positioned in the overlapping portions of the first and second conduits.

According to one exemplary embodiment, the deflector has an outer diameter being the same as the inner diameter of the first conduit. As such, gases flowing from the first conduit must enter the deflector and pass through it on its way into the second conduit. As the deflector is provided at the overlapping portions of the first and second conduits, gases will pass the joint inside the deflector.

According to one exemplary embodiment, the deflector is a short pipe with a solid circumferential wall. Hence, in this embodiment, there are no openings or apertures in the outer circumferential wall of the deflector. Gases may only enter and exit the deflector through openings at the ends thereof.

According to one exemplary embodiment, the deflector is provided with one or more openings in its circumferential wall. One or more openings in the circumferential wall of the deflector may improve the flow characteristics of the gases flowing through the deflector.

The vehicle according to the second aspect of the present invention comprises a conduit system according to the first aspect of the present invention. The first aspect of the invention can beneficially be applied in heavy-duty vehicles, such as trucks, buses and construction equipment. It can also beneficially be used in e.g. boats, ships and cars as well as in industrial engines.

According to the third aspect of the present invention, a method of assembling a conduit system comprising a first conduit having a first engagement portion, wherein the first engagement portion comprises a first slide surface, said first slide surface extending radially outwards from a longitudinal axis of the first conduit at the first engagement portion of the first conduit and has an inclination of 20-90° to said longitudinal axis, comprises:
providing a second conduit having a second engagement portion, wherein the second engagement portion comprises a second slide surface, said second slide surface extending radially outwards from a longitudinal axis of the second conduit at the second engagement portion of the second conduit and has an inclination of 20-90° to said longitudinal axis;
arranging one of the first and second slide surfaces (4, 14) such that it is directed towards the other one of said first and second slide surfaces (4, 14); and
arranging spring means (20) such that they urge one of the first and second slide surfaces (4, 14) towards the other one of said first and second slide surfaces (4, 14.

Advantages of the third aspect of the present invention are largely analogous with the advantages of the first aspect of the present invention. For example, assembling a conduit system according to the present invention provides a conduit system that reduces the risk of failure of the conduit system, is possible to service and re-use undamaged parts of while at the same time provides a reduced risk of fluid leakage also before any failure.

According to one exemplary embodiment, said method further comprises providing a first sealing member between said first and second slide surface. The first sealing member may preferably be of the type described in any one of the exemplary embodiments of the first sealing members mentioned for the first aspect of the present invention. It may also provide the same functionality and advantages as described in relation to each one of the exemplary embodiments of the first aspect of the present invention.

According to one exemplary embodiment, said method further comprises providing a locking means for holding said spring means in a biased condition, in which biased condition said spring means urges one of said first and second slide surfaces towards the other one of said first and second slide surfaces. The locking means may preferably be of the type described in any one of the exemplary embodiments of the locking means mentioned for the first aspect of the present invention. It may also provide the same functionality and advantages as described in relation to each one of the exemplary embodiments of the first aspect of the present invention.

The method of assembling a conduit system according to the third aspect of the present invention may be used for assembling a conduit system according to any one of the exemplary embodiments of the first aspect of the present invention.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a side view of a truck being provided with a conduit system according to the first aspect of the present invention;

FIG. 2 is an exploded side view of a conduit system according to the first aspect of the present invention;

FIG. 3a is a sectioned view of the joint between the first and second conduits in an aligned position;

FIG. 3b is a sectioned view of the joint between the first and second conduits in a tilted position;

FIG. 4 is a perspective view of the assembled conduit system with a portion of it cut away; and

FIG. 5 is a perspective view of another embodiment of the assembled conduit system with a portion of it cut away.

### DETAILED DESCRIPTION OF EXAMPLE EMBODIMENTS OF THE INVENTION

The present invention will now be described more fully hereinafter with reference to the accompanying drawings, in which exemplary embodiments of the invention are shown. The invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout the description.

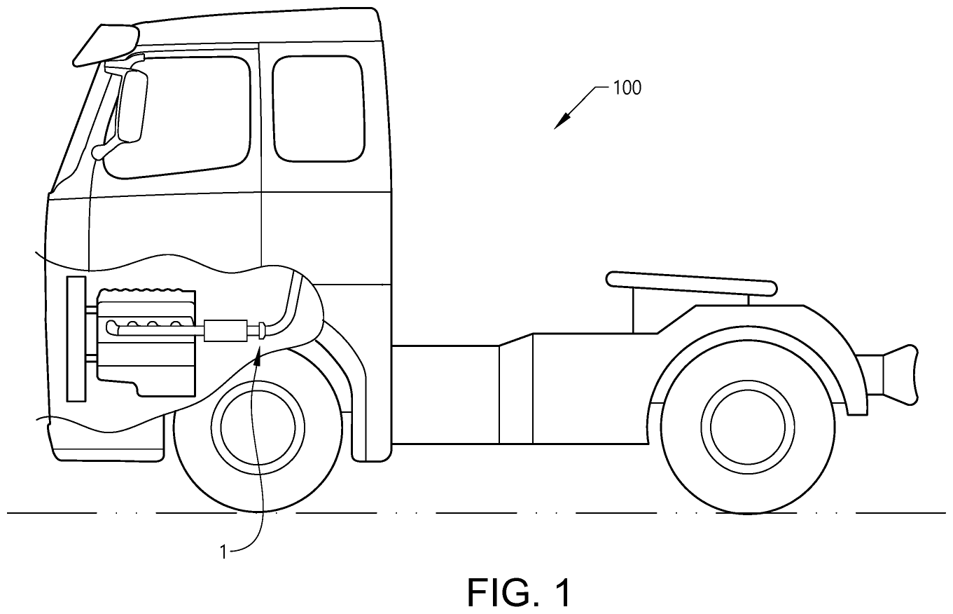

FIG. 1 schematically illustrates a truck 100, on which a conduit system 1 according to the present invention may be used.

The present invention, in both the illustrated embodiments as well as other non-illustrated embodiments falling within the scope of the appended claims, is suitable to use for conduits having outside diameters within a wide range. It is for example to use it for conduits having outside diameters of 25.4 mm to 254 mm. In applications for heavy-duty vehicles, it is common that the conduits have outside diameters within a range of 76.2 to 127 mm. The thickness of the walls of the pipes are commonly within a range of 1 to 6 mm. The conduits may for example be ERW steel pipes, DOM steel pipes, extruded aluminium pipes, cast pipes, aluminium silicon coated steel pipes, stainless steel pipes or other metal conduits of ferrous alloys.

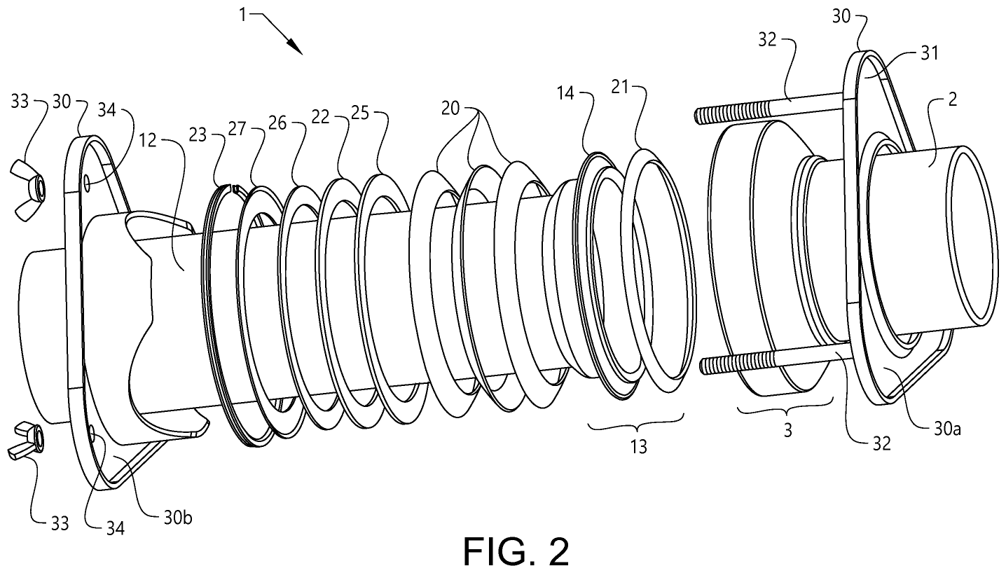

FIGS. 2, 3a, 3b and 4 illustrate an embodiment of the conduit system 1 for conveying a high temperature fluid, such as an exhaust gas from an engine, of the present invention in greater detail. The conduit system 1 comprises a first conduit 2 of rigid character. The first conduit has a first engagement portion 3. The conduit system 1 also comprises a second conduit 12 of flexible character. The second conduit has a second engagement portion 13. The first conduit 2 and the second conduit 12 are adapted to be connected to each other by means of the first and second engagement portions 3, 13.

The first engagement portion 3 comprises a first slide surface 4, which extends radially outwards from a longitudinal axis A of the first conduit 2 at the first engagement portion 3 The radially outwards extending slide surface has an inclination of 20-90° to said longitudinal axis A. In the illustrated embodiment, the inclination is approximately 50-60°. Likewise, the second engagement portion 13 comprises a second slide surface 14. Also 20 the second slide surface extends radially outwards from a longitudinal axis B of the second conduit 12 at the second engagement portion 13. The inclination for the second slide surface is also in the range of 20-90° to the corresponding longitudinal axis B. In the illustrated embodiment, the inclination is approximately 50-60°. As the first and second slide surfaces are intended to slide in relation to each other, it is suitable to have at least approximately the same inclination of them. Therefore, the difference in inclination between the first and second slide surfaces 4, 14 is less than 5°.

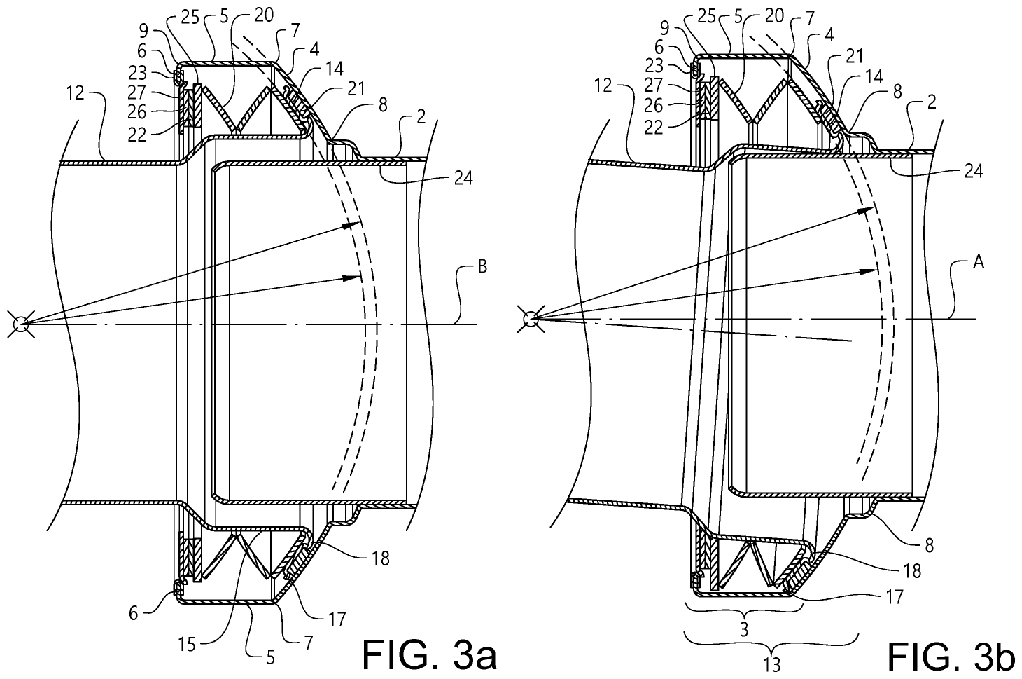

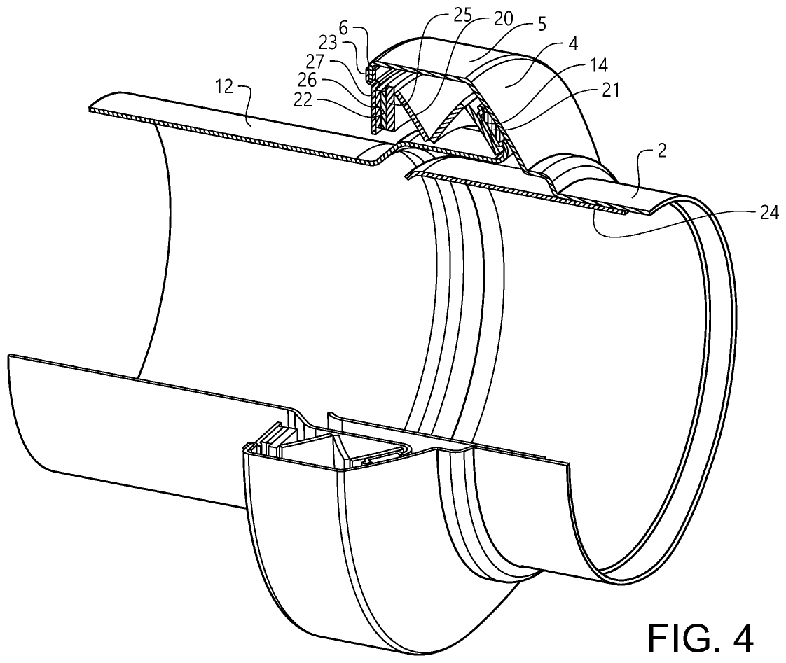

The first engagement portion 3 also comprises an axial extension portion 5 and a flange 6. The axial extension portion 5 is connected to the outermost end 7 of the first slide surface 4. The extension of the axial extension portion 5 is substantially parallel with the longitudinal axis A of the first conduit 2. The flange 6 is connected to an end 9 of the axial extension portion 5 that is furthest away from the first slide surface 4. The flange 6 has a substantially radial extension in relation to the first conduit 2 and is directed from the axial extension portion 7 inwards, i.e. towards the longitudinal axis A of the first conduit 2. The second engagement portion 13 also comprises an axial extension portion 15. The axial extension portion is connected to the innermost end 18 of the second slide surface 14. When the conduit system 1 is assembled, the extension portions 5, 15 of the respective first and second engagement portions 3, 13 overlap each other, as is clearly seen in e.g. FIGS. 3a, 3b and 4.

As can be best seen in FIGS. 3a and 3b, the first and second slide surfaces 4, 14 have in this embodiment a curved shape and as they are rotationally symmetrical, they each define a spherical segment. Alternatively, they may each define a rotational symmetrical ovoid segment. When a slide surface is curved, the angle of inclination of it should be measured as the angle of the chord extending between the innermost 8, 18 and outermost end 7, 17 of the respective slide surface 4, 14.

The conduit system 1 further comprises spring means 20 arranged to urge one of the first and second slide surfaces 4, 14 towards the other one of said first and second slide surfaces 4, 14. The spring means 20 are provided between the axial extension portion 5 of the first engagement portion 3 and the axial extension portion 15 of the second conduit 12. In the illustrated embodiment, it is the second slide surface 14 that is urged towards the first slide surface 4 by the spring means 20. By this arrangement, the first and second slide surfaces 4, 14 form at least a part of a sealing to prevent fluid from escaping the 20 conduit system 1.

A first sealing member 21, in the form of a low-friction graphite gasket, is provided between said first and said second slide surfaces 4, 14. Hence, in this embodiment, the slide surfaces are not in contact with each other. The first sealing member 21 is held in a constant position in relation to the second slide surface 14 and is arranged to be slideable in relation to the first slide surface 4. In the illustrated embodiment, the first sealing member 21 is held in a constant position in relation to the second slide surface 14 by means of the shape of the second slide surface 14. As can be seen in the figures, the first slide surface has a holding portion or cradle in which the first sealing member 21 is provided. It is however also conceivable to hold the sealing member in a constant position to the second slide surface 14 by other means as well. For example, it may be welded or glued to the first slide surface 14. The purpose of the first sealing member 21 is both to seal the joint, but also to provide a means for simplifying both the rotational movement and the tiltable movement of the second conduit in relation to the first conduit.

The conduit system 1 further comprises a second sealing member 22. The second sealing member 22 is provided on the opposite side of said spring means 20 as the first sealing member 21. Also the second sealing member 22 is a low-friction graphite gasket. The purpose of the second sealing member 22 is both to seal the joint, but also to provide a means for simplifying the rotational movement of the second conduit in relation to the first conduit.

A locking means 23 for locking the spring means 20 in a biased configuration in which it urges one of the first and second slide surfaces 4, 14 towards the other one of said first and second slide surfaces 4, 14 is also provided. In the illustrated embodiment, the locking means 23 is a circlip, i.e. a semi-flexible ring with open ends, that can be snapped into place around the flange 6.

Between the spring means 20 and the second sealing member 22, a first flat washer 25 is provided. Between the second sealing member 22 and the locking means 23, a second 26 and third 27 flat washers are provided. The purpose of the flat washers 25, 26 and 27 are to assist in obtaining a good distribution of the spring force and to provide a flat mating surface for the second sealing member 22. Even though flat washers are illustrated as suitable for obtaining these functions, it is of course possible to use other means for achieving this.

The conduit system 1 also comprises a flow guide member, e.g. a deflector 24, provided at least partly in the first and second engagement portions 3, 13 of the first and second conduits 2, 12, respectively. Hence, the flow guide member 24 is provided in the joint between the first and second conduits 2, 12. It is in the form of a short pipe with open ends of sheet metal. It has an outer diameter being substantially the same as the inner diameter of the first conduit. Hence, gases flowing from the first conduit will enter the flow guide member 24 and be directed through it and into the second conduit. The risk of fluid leakage through the joint is thereby reduced.

As can be best seen in FIGS. 3a and 3b, the first and second slide surfaces 4, 14 have in this embodiment a curved shape and the second slide surface 14, by means of the first sealing member 21, can slide along the first slide surface 4 even if they are not in direct contact with each other. In FIG. 3a, the first and second conduits are aligned with each other and the second slide surface 14 is thereby centrally positioned in relation to the first slide surface 4. In FIG. 3b, the second conduit 12 is tilted a few degrees in relation to the first conduit 2. The part of the second slide surface 14 positioned in the upper portion of the drawing has slid downwards against the first slide surface 4 and is now close to the innermost end 8 of that portion of the first slide surface 4. Hence, it has moved closer to the axis A of the first conduit 2. Likewise, at the bottom of the drawing, the portion of the second slide surface 14 has also slid downwards and is now closer to the outermost end 7 of that portion of the first slide surface 4. In fact, the outermost end 17 of the second slide surface 14 is in contact with the outermost end 7 of the first slide surface. Hence, the first slide surface has moved further away from the axis A of the first conduit 2. As can also be seen in FIG. 3b, the upper portion of the second conduit 12 is now abutting the flow guide member 24. Hence, the flow guide member 24 stops the first conduit from moving too far when the conduits are tilted in relation to each other. By using the flow guide member 24 as a stop, less forces have to be taken up by the spring means 20.

The first and second conduits can also rotate in relation to each other. The ovoid shaped segment, such as a spherical shaped segment, of the first and second slide surfaces allow this rotation without imparting a rotating movement to the second conduit. In other words, when the first conduit rotates, the first sealing member 21, and thereby the second slide 14 and second conduit 12, are still and slides on the first slide surface 4. If it instead was the second conduit that was rotated, the first sealing member 21 would also slide on the first slide surface, leaving the first conduit in its previous position.

When the conduit system 1 should be assembled, the components are provided to each other in the order illustrated in FIG. 2. Hence, as a first step a first conduit 2 having a first engagement portion 3 comprising a first slide surface 4 extending radially outwards from a longitudinal axis A of the first conduit 2 at the first engagement portion 3 of the first conduit 2 and having an inclination of 20-90° to said longitudinal axis A is provided. Thereafter, as a second step, a second conduit 12 having a second engagement portion 13 comprising a second slide surface 14 extending radially outwards from a longitudinal axis B of the second conduit 12 at the second engagement portion and having an inclination of 20-90° to said longitudinal axis B is provided. As the third step one of the first and second slide surfaces 4, 14 is arranged such that it is directed towards the other one of said first and slide surfaces 4, 14. As a fourth step, spring means 20 are arranged to urge one of first and second slide surfaces 4, 14 towards the other one of said first and second slide surfaces. The method may further comprise providing a first sealing member 21 between said first and second slide surfaces 4, 14 and providing a locking means 23 for holding said spring means 20 in a biased condition, in which biased condition said spring means 20 urges one of said first and second slide surfaces 4, 14 towards the other one of said first and second slide surfaces 4, 14. The method may also comprise the provision of a second sealing member 22 and at least one flat washer 25, 26, 27.

A fixing tool 30 comprising a first and second part 30a, 30b may be used for assembling the conduit system 1. The first part 30a of the fixing tool 30 comprises a holding portion 31 and three elongate and threaded rods 32 (of which two is shown in the drawings). The holding portion 31 comprises a centrally arranged large hole, dimensioned so that the holding portion 31 can be arranged to circumscribe the first conduit 2, while at the same time not be able to pass by the radially extending first slide surface 4. The second part 30b comprises three holes 34 (of which two is shown in the drawings) dimensioned to be 15 able to receive a respective one of the elongate rods 32. The second part 30b also comprises a centrally arranged large hole, dimensioned so that the second part 30b can be arranged to circumscribe the second conduit 12, while at the same time not be able to pass by the radially extending second slide surface 14. The fixing tool also comprises three wing nuts 33 (of which two is shown in the drawings) dimensioned to threadedly engage the elongate rods 32.

In order to assemble the conduit system, the first part 30a is provided on the first conduit and the second part 30b is provided on the second conduit, and all components that is to be included in the assembly are provided in the correct order between the first and second parts 30a, 30b of the fixing tool. This is clearly illustrated in FIG. 2. The elongated rods 32 are thereafter inserted into the holes of the second part 30b and the wing nuts 33 are threadedly engaged with the rods 32. By tightening the wing nuts 33, the spring means 20 are compressed and the first and second slide surfaces 4, 14 are brought towards each other. When the compression of the spring means is large enough, the locking means 23 is attached to the flange 6 and thereby locks all components to each other in the desired axial relationship. Once that has been done, the wing nuts 33 may be unthreded from the rods 32 and the fixing tool can be removed. Hence, the fixing tool is not positioned at the conduit system 1 when the conduit system is in use. FIG. 4 illustrates the assembled conduit system when the fixing tool 30 has been removed. A specific fixing tool has been described above. It is however conceivable to use many other fixing tools for compressing the spring means 20 and providing for locking it in a biased configuration in which it urges the first and second slide surfaces 4, 14 towards each other.

It is to be understood that the present invention is not limited to the embodiment described above and illustrated in FIGS. 2-4; rather, the skilled person will recognize that many changes and modifications may be made within the scope of the appended claims.

For example, in the illustrated embodiment, said spring means 20 is a Belleville washer. It is however also conceivable to use other types of spring means, such as a wave washer, a coil spring or a bellow spring. Furthermore, the locking means 23 have been illustrated as a circlip. Many other alternatives are however possible, such as e.g. rivets, bolts or welds. Also, the first and second sealing members 21, 22 have been illustrated as graphite gaskets. It is however also conceivable with any other type of low-friction sealing members, such as low-friction material coated bearings or low-friction metal gaskets.

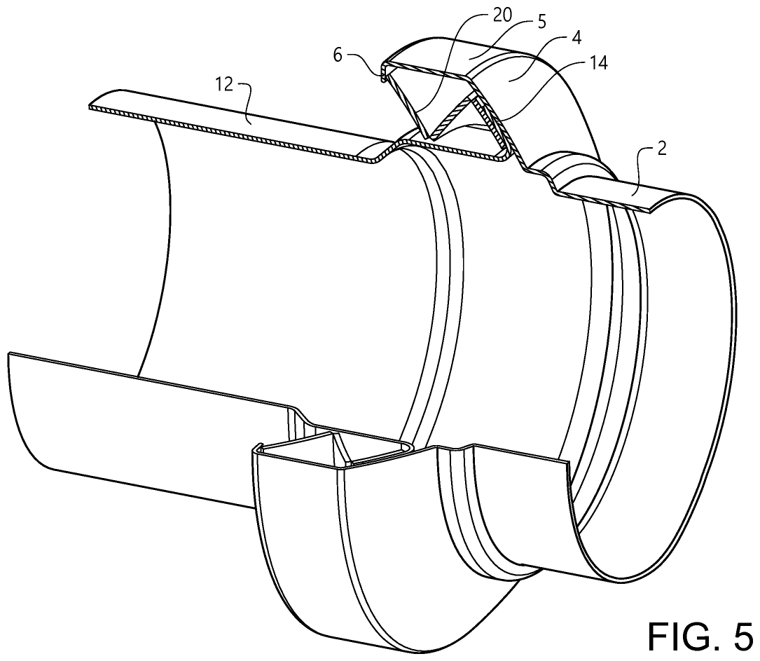

Another embodiment of the present invention is illustrated in FIG. 5. This embodiment has many features in common with the first embodiment illustrated above, and similar features, functions and advantages will not be elaborated upon again. Instead, the main difference between the embodiment of FIG. 5 and the embodiment of FIGS. 2-4, is that this embodiment has fewer components. As can be seen in FIG. 5, the first and second slide surfaces 4, 14 abut each other and are intended to slide against each other without the use of a first sealing member. Therefore, in this embodiment, the second slide surface 14 is a straight or ovoid, such as spherical, segment having a similar or the same inclination as the first slide surface 4. Also, the spring means 20 are in direct contact with the flange 6 and held in its biased condition by this contact. Therefore, the second sealing member, the flat washers and the locking means that are described for the first embodiment, are not necessary in this embodiment. Furthermore, the flow guide member 24 is also not used in this embodiment.

This embodiment may be assembled by means of the same fixing tool 32 as described above for the first embodiment, and by the provision of the different components in the correct order as described above for the first embodiment.

It is to be understood that the present invention is also not limited to the embodiment described above and illustrated in FIG. 5; rather, the skilled person will recognize that many changes and modifications may be made within the scope of the appended claims.

1. A conduit system for conveying a high temperature fluid, such as an exhaust gas from an engine, said conduit system comprises a first conduit having a first engagement portion, and a second conduit having a second engagement portion, wherein the first conduit and the second conduit are adapted to be connected to each other by means of the first and second engagement portions, characterized in that the first engagement portion comprises a first slide surface, said first slide surface extending radially outwards from a longitudinal axis of the first conduit at the first engagement portion of the first conduit and has an inclination of 20-90° to said longitudinal axis, wherein the second engagement portion comprises a second slide surface, said second slide surface extending radially outwards from a longitudinal axis of the second conduit at the second engagement portion of the second conduit and has an inclination of 20-90° to said longitudinal axis, and wherein said conduit system further comprises spring means arranged to urge one of the first and second slide surfaces towards the other one of said first and second slide surfaces, such that the first and second slide surfaces form at least a part of a sealing to prevent fluid from escaping the conduit system.

2. A conduit system according to claim 1, wherein the difference in inclination between the first and second slide surfaces is less than 5°.

3. A conduit system according to claim 1, wherein said first conduit is of a rigid character and said second conduit is of a flexible character.

4. A conduit system according to claim 1, wherein at least one of said first and second slide surfaces have a curved shape.

5. A conduit system according to claim 1, wherein said spring means is one of a Belleville washer, wave washer, bellow washer or a coil spring.

6. A conduit system according to claim 1, wherein a first sealing member is provided between said first and said second slide surfaces.

7. A conduit system according to claim 6, wherein said first sealing member is a low friction gasket, such as a graphite gasket.

8. A conduit system according to claim 1, wherein said conduit system further comprises a second sealing member.

9. A conduit system according to claim 1, wherein said conduit system further comprises a locking means for locking the spring means in a biased configuration in which it urges one of the first and second slide surfaces towards the other one of said first and second slide surfaces.

10. A conduit system according to claim 9, wherein said locking means is a circlip.

11. A conduit system according to claim 1, wherein said conduit system further comprises a flow guide member provided at least partly in the first and second engagement portions of the first and second conduits, respectively.

12. The conduit system according to claim 1, wherein the conduit system resides within a vehicle.

13. A method of assembling a conduit system comprising a first conduit having a first engagement portion, wherein the first engagement portion comprises a first slide surface, said first slide surface extending radially outwards from a longitudinal axis of the first conduit at the first engagement portion of the first conduit and has an inclination of 20-90° to said longitudinal axis, said method being characterized by the steps of:
providing a second conduit having a second engagement portion, wherein the second engagement portion comprises a second slide surface, said second slide surface extending radially outwards from a longitudinal axis of the second conduit at the second engagement portion of the second conduit and has an inclination of 20-90° to said longitudinal axis;
arranging one of the first and second slide surfaces such that it is directed towards the other one of said first and second slide surfaces; and
arranging spring means such that they urge one of the first and second slide surfaces towards the other one of said first and second slide surfaces.

14. A method according to claim 13, said method further comprises providing a first sealing member between said first and second slide surfaces.

15. A method according to claim 13, said method further comprises providing a locking means for holding said spring means in a biased condition, in which biased condition said spring means urges one of said first and second slide surfaces towards the other one of said first and second slide surfaces.
